(19) United States
(12) Patent Application Publication
(10) Pub. No.: US 2018/0091812 A1
(43) Pub. Date: Mar. 29, 2018

(54) VIDEO COMPRESSION SYSTEM PROVIDING SELECTION OF DEBLOCKING FILTERS PARAMETERS BASED ON BIT-DEPTH OF VIDEO DATA

(71) Applicant: Apple Inc., Cupertino, CA (US)

(72) Inventors: Mei Guo, San Jose, CA (US); Jae Hoon Kim, San Jose, CA (US); Jun Xin, Cupertino, CA (US); Feng Yi, San Jose, CA (US); Yeping Su, Sunnyvale, CA (US); Dazhong Zhang, Milpitas, CA (US); Chris Chung, Sunnyvale, CA (US); Xiaosong Zhou, Campbell, CA (US); Hsi-Jung Wu, San Jose, CA (US)

(21) Appl. No.: 15/275,076

(22) Filed: Sep. 23, 2016

(51) Int. Cl. H04N 19/117; H04N 19/86; H04N 19/14; H04N 19/15; H04N 19/61; H04N 19/124; H04N 19/13; H04N 19/159

(52) U.S. Cl. CPC H04N 19/117; H04N 19/86; H04N 19/14; H04N 19/15; H04N 19/182; H04N 19/124; H04N 19/13; H04N 19/159; H04N 19/61

(57) ABSTRACT

Techniques are disclosed for selecting deblocking filter parameters in a video decoding system. According to these techniques, a boundary strength parameter may be determined based, at least in part, on a bit depth of decoded video data. Activity of a pair of decoded pixel blocks may be classified based, at least in part, on the determined boundary strength parameter, and when a level of activity indicates that deblocking filtering is to be applied to the pair of pixel blocks, pixel block content at a boundary between the pair of pixel blocks may be filtered using filtering parameters derived at least in part based on the bit depth of the decoded video data. The filtering parameters may decrease strength with increasing bit depth of the decoded video data, which improves quality of the decoded video data.

### BACKGROUND

The present disclosure is directed to video decoding techniques and, in particular, to selection of deblocking filter parameters.

A deblocking filter is a video filter applied to decoded compressed video to improve visual quality and prediction performance by smoothing the sharp edges that can arise from block-based coding artifacts. Filtering aims to improve the appearance of decoded pictures by reducing these artifacts.

Deblocking filtering techniques are defined in the ITU H.264 and H.265 (also “HEVC”) coding protocols. Deblocking filtering must be performed “in loop;” they are applied to reference frames that are stored for use in prediction of other image data to be coded after the reference frames are coded. When a stream is encoded, the filter strength can be selected, or the filter can be switched off entirely. Otherwise, the filter strength is determined by coding parameters (including coding modes, motion vectors, reference frames and coded residue) of adjacent blocks, quantization step size, and the steepness of the luminance gradient between blocks.

The filter operates on the edges of each 4×4 or 8×8 block in the luma and chroma planes of each picture. Only the edges that are either prediction block edges or transform block edges are subject to deblocking. Each small block's edge is assigned a boundary strength based on the coding modes (intra/inter) of the blocks, whether references (in motion prediction and reference frame choice) differ, whether any of the blocks have coded residue, and whether it is a luma or chroma edge. Stronger levels of filtering are assigned by this scheme where there is likely to be more distortion. The filter can modify as many as three samples on either side of a given block edge (in the case where an edge is a luma edge that has “Strong Filtering Mode”). In most cases it can modify one or two samples on either side of the edge (depending on the quantization step size, the tuning of the filter strength by the encoder, the result of an edge detection test, and other factors).

The inventors have determined that presently-available deblocking techniques do not provide optimal performance. Accordingly, they have identified a need in the art for deblocking techniques that improve quality of image data recovered by video decoders.

### BRIEF DESCRIPTION OF THE DRAWINGS

FIGS. 1A, 1B, and 1C are simplified block diagrams of a video delivery system according to an embodiment of the present disclosure.

FIG. 2 is a functional block diagram of a coding system according to an embodiment of the present disclosure.

FIG. 3 is a functional block diagram of a decoding system according to an embodiment of the present disclosure.

FIG. 4 illustrates a method for selecting deblocking filtering parameters according to an embodiment of the present invention.

FIG. 5 illustrates exemplary relationships among pixels for deblocking filtering.

### DETAILED DESCRIPTION

Embodiments of the present invention provide techniques for selecting deblocking filter parameters in a video decoding system. According to these techniques, a boundary strength parameter may be determined based, at least in part, on a bit depth of decoded video data. Activity of a pair of decoded pixel blocks may be classified based, at least in part, on a bit depth of decoded video data, and when a level of activity indicates that deblocking filtering is to be applied to the pair of pixel blocks, pixel block content at a boundary between the pair of pixel blocks may be filtered using filtering parameters derived at least in part based on the bit depth of the decoded video data. The filtering parameters may decrease strength with increasing bit depth of the decoded video data, which improves quality of the decoded video data.

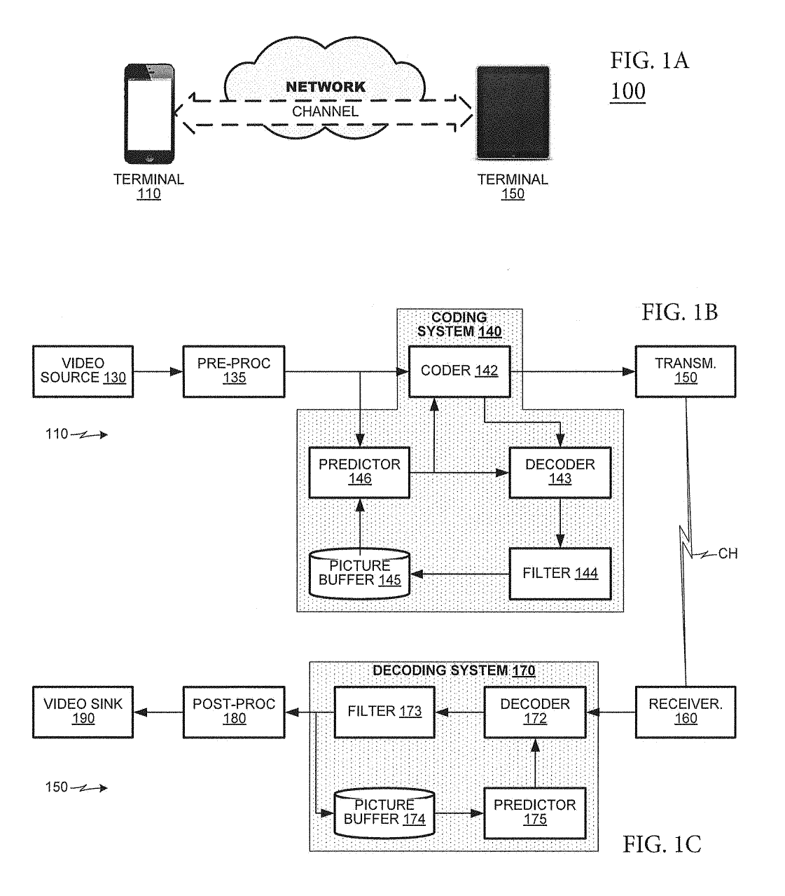

FIG. 1(a) is a simplified block diagram of a video delivery system 100 according to an embodiment of the present disclosure. The system 100 may include a plurality of terminals 110, 150 interconnected via a network. The terminals 110, 150 may code video data for transmission to their counterparts via the network. Thus, a first terminal 110 may capture video data locally, code the video data and transmit the coded video data to the counterpart terminal 150 via a channel. The receiving terminal 150 may receive the coded video data, decode it, and render it locally, for example, on a display at the terminal 150. If the terminals are engaged in bidirectional exchange of video data, then the terminal 150 may capture video data locally, code the video data and transmit the coded video data to the counterpart terminal 110 via another channel. The receiving terminal 110 may receive the coded video data transmitted from terminal 150, decode it, and render it locally, for example, on its own display.

A video coding system 100 may be used in a variety of applications. In a first application, the terminals 110, 150 may support real time bidirectional exchange of coded video to establish a video conferencing session between them. In another application, a terminal 110 may code pre-produced video (for example, television or movie programming) and store the coded video for delivery to one or, often, many downloading clients (e.g., terminal 150). Thus, the video being coded may be live or pre-produced, and the terminal 110 may act as a media server, delivering the coded video according to a one-to-one or a one-to-many distribution model. For the purposes of the present discussion, the type of video and the video distribution schemes are immaterial unless otherwise noted.

In FIG. 1(a), the terminals 110, 150 are illustrated as smart phones and tablet computers, respectively, but the principles of the present disclosure are not so limited. Embodiments of the present disclosure also find application with computers (both desktop and laptop computers), computer servers, media players, dedicated video conferencing equipment and/or dedicated video encoding equipment.

The network represents any number of networks that convey coded video data between the terminals 110, 150, including for example wireline and/or wireless communication networks. The communication network may exchange data in circuit-switched or packet-switched channels. Representative networks include telecommunications networks, local area networks, wide area networks, and/or the Internet. For the purposes of the present discussion, the architecture and topology of the network are immaterial to the operation of the present disclosure unless otherwise noted.

FIG. 1(b) is a functional block diagram illustrating components of an encoding terminal 110. The encoding terminal may include a video source 130, a pre-processor 135, a coding system 140, and a transmitter 150. The video source 130 may supply video to be coded. The video source 130 may be provided as a camera that captures image data of a local environment or a storage device that stores video from some other source. The pre-processor 135 may perform signal conditioning operations on the video to be coded to prepare the video data for coding. For example, the preprocessor 135 may alter frame rate, frame resolution, and other properties of the source video. The preprocessor 135 also may perform filtering operations on the source video.

The coding system 140 may perform coding operations on the video to reduce its bandwidth. Typically, the coding system 140 exploits temporal and/or spatial redundancies within the source video. For example, the coding system 140 may perform motion compensated predictive coding in which video frame or field pictures are parsed into sub-units (called “pixel blocks,” for convenience), and individual pixel blocks are coded differentially with respect to predicted pixel blocks, which are derived from previously-coded video data. A given pixel block may be coded according to any one of a variety of predictive coding modes, such as:
intra-coding, in which an input pixel block is coded differentially with respect to previously coded/decoded data of a common frame;
single prediction inter-coding, in which an input pixel block is coded differentially with respect to data of a previously coded/decoded frame; and
bi-predictive inter-coding, in which an input pixel block is coded differentially with respect to data of a pair of previously coded/decoded frames.
Combined inter-intra coding in which an input pixel block is coded differentially with respect to data from both a previously coded/decoded frame and data from the current/common frame.
Multi-hypothesis inter-intra coding, in which an input pixel block is coded differentially with respect to data from several previously coded/decoded frames, as well as potentially data from the current/common frame.
   Pixel blocks also may be coded according to other coding modes such as the Transform Skip and RRU coding modes discussed earlier.

The coding system 140 may include a coder 142, a decoder 143, an in-loop filter 144, a picture buffer 145, and a predictor 146. The coder 142 may apply the differential coding techniques to the input pixel block using predicted pixel block data supplied by the predictor 146. The decoder 143 may invert the differential coding techniques applied by the coder 142 to a subset of coded frames designated as reference frames. The in-loop filter 144 may apply filtering techniques, including deblocking filtering, to the reconstructed reference frames generated by the decoder 143. The picture buffer 145 may store the reconstructed reference frames for use in prediction operations. The predictor 146 may predict data for input pixel blocks from within the reference frames stored in the picture buffer.

The transmitter 150 may transmit coded video data to a decoding terminal via a channel CH.

FIG. 1(c) is a functional block diagram illustrating components of a decoding terminal 150 according to an embodiment of the present disclosure. The decoding terminal may include a receiver 160 to receive coded video data from the channel, a video decoding system 170 that decodes coded data; a post-processor 180, and a video sink 190 that consumes the video data.

The receiver 160 may receive a data stream from the network and may route components of the data stream to appropriate units within the terminal 200. Although FIGS. 1(b) and 1(c) illustrate functional units for video coding and decoding, terminals 110, 120 typically will include coding/decoding systems for audio data associated with the video and perhaps other processing units (not shown). Thus, the receiver 160 may parse the coded video data from other elements of the data stream and route it to the video decoder 170.

The video decoder 170 may perform decoding operations that invert coding operations performed by the coding system 140. The video decoder may include a decoder 172, an in-loop filter 173, a picture buffer 174, and a predictor 175. The decoder 172 may invert the differential coding techniques applied by the coder 142 to the coded frames. The in-loop filter 144 may apply filtering techniques, including deblocking filtering, to reconstructed frame data generated by the decoder 172. For example, the in-loop filter 144 may perform various filtering operations (e.g., de-blocking, de-ringing filtering, sample adaptive offset processing, and the like). The filtered frame data may be output from the decoding system. The picture buffer 174 may store reconstructed reference frames for use in prediction operations. The predictor 175 may predict data for input pixel blocks from within the reference frames stored by the picture buffer according to prediction reference data provided in the coded video data.

The post-processor 180 may perform operations to condition the reconstructed video data for display. For example, the post-processor 180 may perform various filtering operations (e.g., de-blocking, de-ringing filtering, and the like), which may obscure visual artifacts in output video that are generated by the coding/decoding process. The post-processor 180 also may alter resolution, frame rate, color space, etc. of the reconstructed video to conform it to requirements of the video sink 190.

The video sink 190 represents various hardware and/or software components in a decoding terminal that may consume the reconstructed video. The video sink 190 typically may include one or more display devices on which reconstructed video may be rendered. Alternatively, the video sink 190 may be represented by a memory system that stores the reconstructed video for later use. The video sink 190 also may include one or more application programs that process the reconstructed video data according to controls provided in the application program. In some embodiments, the video sink may represent a transmission system that transmits the reconstructed video to a display on another device, separate from the decoding terminal; for example, reconstructed video generated by a notebook computer may be transmitted to a large flat panel display for viewing.

The foregoing discussion of the encoding terminal and the decoding terminal (FIGS. 1(b) and 1(c)) illustrates operations that are performed to code and decode video data in a single direction between terminals, such as from terminal 110 to terminal 150 (FIG. 1(a)). In applications where bidirectional exchange of video is to be performed between the terminals 110, 150, each terminal 110, 150 will possess the functional units associated with an encoding terminal (FIG. 1(b)) and each terminal 110, 150 also will possess the functional units associated with a decoding terminal (FIG. 1(c)). Indeed, in certain applications, terminals 110, 150 may exchange multiple streams of coded video in a single direction, in which case, a single terminal (say terminal 110) will have multiple instances of an encoding terminal (FIG. 1(b)) provided therein. Such implementations, although not illustrated in FIG. 1, are fully consistent with the present discussion.

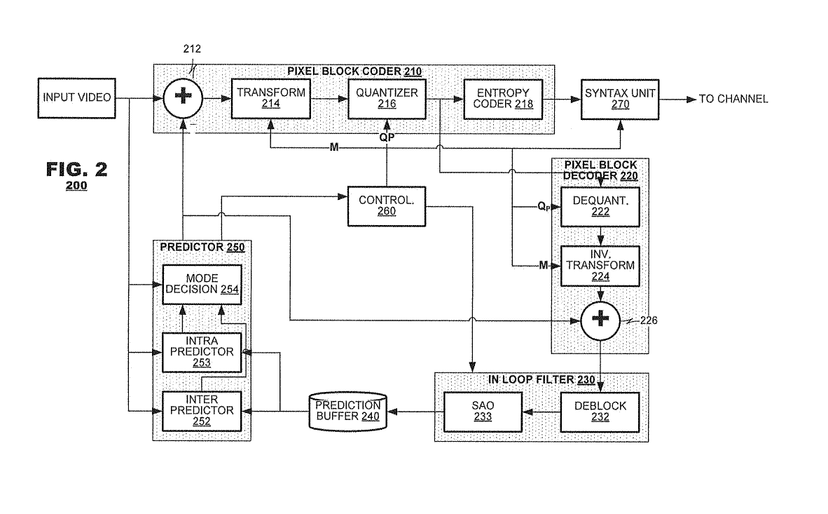

FIG. 2 is a functional block diagram of a coding system 200 according to an embodiment of the present disclosure. The system 200 may include a pixel block coder 210, a pixel block decoder 220, an in-loop filter system 230, a prediction buffer 240, a predictor 250, a controller 260, and a syntax unit 270. The pixel block coder and decoder 210, 220 and the predictor 250 may operate iteratively on individual pixel blocks of a frame. The predictor 250 may predict data for use during coding of a newly-presented input pixel block. The pixel block coder 210 may code the new pixel block by predictive coding techniques and present coded pixel block data to the syntax unit 270. The pixel block decoder 220 may decode the coded pixel block data, generating decoded pixel block data therefrom. The in-loop filter 230 may perform various filtering operations on decoded frame data that is assembled from the decoded pixel blocks obtained by the pixel block decoder 220. The filtered frame data may be stored in the prediction buffer 240 where it may be used as a source of prediction of a later-received pixel block. The syntax unit 270 may assemble a data stream from the coded pixel block data which conforms to a governing coding protocol.

The pixel block coder 210 may include a subtractor 212, a transform unit 214, a quantizer 216, and an entropy coder 218. The pixel block coder 210 may accept pixel blocks of input data at the subtractor 212. The subtractor 212 may receive predicted pixel blocks from the predictor 250 and generate an array of pixel residuals therefrom representing a difference between the input pixel block and the predicted pixel block. The transform unit 214 may apply a transform to the pixel residual s output from the subtractor 212 to convert the residual data from the pixel domain to a domain of transform coefficients. The quantizer 216 may perform quantization of transform coefficients output by the transform unit 214. The quantizer 216 may be a uniform or a non-uniform quantizer. The entropy coder 218 may reduce bandwidth of the output of the quantizer by coding the output, for example, by variable length code words.

During operation, the quantizer 216 may operate according to coding parameters that govern each unit's operation. The quantizer 216 may operate according to a quantization parameter (Q_{P}) that determines a level of quantization to apply to the transform coefficients input to the quantizer 216. The quantization parameter may be selected by a controller 260 based on an estimate of a target bitrate that each coded frame should match and also based on analyses of each frame's image content. The quantization parameters Q_{P} may be signaled in coded video data output by the coding system 200, either expressly or impliedly.

The transform unit 214 may operate in a variety of transform modes as events warrant. For example, the transform unit 214 may be selected to apply a DCT, a DST, a Walsh-Hadamard transform, a Haar transform, a Daubechies wavelet transform, or the like. In an embodiment, a controller 260 may select a coding mode M to be applied by the transform unit 214 and may configure the transform unit 214 accordingly. The coding mode M also may be signaled in the coded video data, either expressly or impliedly.

The pixel block decoder 220 may invert coding operations of the pixel block coder 210. For example, the pixel block decoder 220 may include a dequantizer 222, an inverse transform unit 224, and an adder 226. The pixel block decoder 220 may take its input data from an output of the quantizer 216. Although permissible, the pixel block decoder 220 need not perform entropy decoding of entropy-coded data since entropy coding is a lossless event. The dequantizer 222 may invert operations of the quantizer 216 of the pixel block coder 210. The dequantizer 222 may perform uniform or non-uniform de-quantization as specified by the decoded signal Q_{P}. Similarly, the inverse transform unit 224 may invert operations of the transform unit 214 and it may use the same transform mode M as its counterpart in the pixel block coder 210.

The adder 226 may invert operations performed by the subtractor 212. It may receive the same prediction pixel block from the predictor 250 that the subtractor 212 used in generating residual signals. The adder 226 may add the prediction pixel block to reconstructed residual values output by the inverse transform unit 224 and may output reconstructed pixel block data. Coding and decoding operations of the pixel block coder 210 and the pixel block decoder 220 are lossy processes and, therefore, decoded video data output by the pixel block decoder likely will exhibit some loss of content as compared to the input data that is supplied to the pixel block coder 210.

Where the pixel block coder 210 and pixel block decoder 220 operates on pixel block-sized increments of an image, the in loop filter 230 may operate on reassembled frames made up of decoded pixel blocks. The in-loop filter 230 may perform various filtering operations on the reassembled frames. For example, the in-loop filter 230 may include a deblocking filter 232 and a sample adaptive offset (“SAO”) filter 233. The deblocking filter 232 may filter data at seams between reconstructed pixel blocks to reduce discontinuities between the pixel blocks that arise due to coding losses. The deblocking filter may operate according to filtering parameters that are selected based on a bit depth of the decoded image data. SAO filters may add offsets to pixel values according to an SAO “type,” for example, based on edge direction/shape and/or pixel/color component level. The in-loop filter 230 may operate according to parameters that are selected by the controller 260.

The prediction buffer 240 may store filtered frame data for use in later prediction of other pixel blocks. Different types of prediction data are made available to the predictor 250 for different prediction modes. For example, for an input pixel block, intra prediction takes a prediction reference from decoded data of the same frame in which the input pixel block is located. Thus, the prediction buffer 240 may store decoded pixel block data of each frame as it is coded. For the same input pixel block, inter prediction may take a prediction reference from previously coded and decoded frame(s) that are designated as “reference frames.” Thus, the prediction buffer 240 may store these decoded reference frames.

As discussed, the predictor 250 may supply prediction data to the pixel block coder 210 for use in generating residuals. The predictor 250 may include an inter predictor 252, an intra predictor 253 and a mode decision unit 254. The inter predictor 252 may receive pixel block data representing a new pixel block to be coded and may search the prediction buffer 240 for pixel block data from reference frame(s) for use in coding the input pixel block. The inter predictor 252 may support a plurality of prediction modes, such as P mode coding and B mode coding. The inter predictor 252 may select an inter prediction mode and supply prediction data that provides a closest match to the input pixel block being coded. The inter predictor 252 may generate prediction reference indicators, such as motion vectors, to identify which portion(s) of which reference frames were selected as source(s) of prediction for the input pixel block.

The intra predictor 253 may support Intra (I) mode coding. The intra predictor 253 may search from among coded pixel block data from the same frame as the pixel block being coded that provides a closest match to the input pixel block. The intra predictor 253 also may generate prediction reference indicators to identify which portion of the frame was selected as a source of prediction for the input pixel block.

The mode decision unit 254 may select a final coding mode to be applied to the input pixel block. Typically, the mode decision unit 254 selects the prediction mode that will achieve the lowest distortion when video is decoded given a target bitrate. Exceptions may arise when coding modes are selected to satisfy other policies to which the coding system 200 adheres, such as satisfying a particular channel behavior, or supporting random access or data refresh policies. The mode decision unit 254 may output the prediction data to the pixel block coder and decoder 210, 220 and may supply to the controller 260 an identification of the selected prediction mode along with the prediction reference indicators corresponding to the selected mode.

The controller 260 may control overall operation of the coding system 200. The controller 260 may select operational parameters for the pixel block coder 210 and the predictor 250 based on analyses of input pixel blocks and also external constraints, such as coding bitrate targets and other operational parameters. As is relevant to the present discussion, when it selects quantization parameters QP, the use of uniform or non-uniform quantizers, and/or the transform mode M, it may provide those parameters to the syntax unit 270, which may include data representing those parameters in the data stream of coded video data output by the system 200. During operation, the controller 260 may revise operational parameters of the quantizer 216 and the transform unit 214 at different granularities of image data, either on a per pixel block basis or on a larger granularity (for example, per frame, per slice, per largest coding unit (“LCU”) or another region).

Additionally, as discussed, the controller 260 may control operation of the in-loop filter 230 and the prediction unit 250. Such control may include, for the prediction unit 250, mode selection (lambda, modes to be tested, search windows, distortion strategies, etc.), and, for the in-loop filter 230, selection of filter parameters, reordering parameters, weighted prediction, etc.

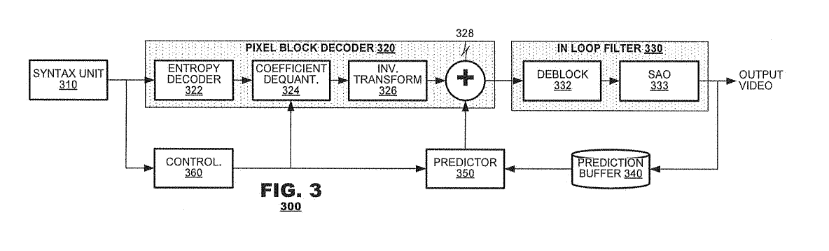

FIG. 3 is a functional block diagram of a decoding system 300 according to an embodiment of the present disclosure. The decoding system 300 may include a syntax unit 310, a pixel-block decoder 320, an in-loop filter 330, a prediction buffer 340, a predictor 350 and a controller 360. The syntax unit 310 may receive a coded video data stream and may parse the coded data into its constituent parts. Data representing coding parameters may be furnished to the controller 360 while data representing coded residuals (the data output by the pixel block coder 210 of FIG. 2) may be furnished to the pixel block decoder 320. The pixel block decoder 320 may invert coding operations provided by the pixel block coder (FIG. 2). The in-loop filter 330 may filter reassembled frames built from decoded pixel block data. The filtered frame data may be output from the system 300 for display as output video. Filtered reference frames also may be stored in the prediction buffer 340 for use in prediction operations. The predictor 350 may supply prediction data to the pixel block decoder 320 as determined by coding data received in the coded video data stream.

The pixel block decoder 320 may include an entropy decoder 322, a dequantizer 324, an inverse transform unit 326, and an adder 328. The entropy decoder 322 may perform entropy decoding to invert processes performed by the entropy coder 218 (FIG. 2). The dequantizer 324 may invert operations of the quantizer 216 of the pixel block coder 210 (FIG. 2). It may use the quantization parameters Q_{P} and the quantizer mode data M that are provided in the coded video data stream. The adder 328 may invert operations performed by the subtractor 212 (FIG. 2). It may receive a prediction pixel block from the predictor 350 as determined by prediction references in the coded video data stream. The adder 328 may add the prediction pixel block to reconstructed residual values output by the inverse transform unit 326 and may output decoded pixel block data.

The in-loop filter 330 may perform various filtering operations on reconstructed pixel block data. As illustrated, the in-loop filter 330 may include a deblocking filter 332 and an SAO filter 333. The deblocking filter 332 may filter data at seams between reconstructed pixel blocks to reduce discontinuities between the pixel blocks that arise due to coding. The deblocking filter may operate according to filtering parameters that are selected based on a bit depth of the decoded image data. SAO filters may add offset to pixel values according to an SAO type, for example, based on edge direction/shape and/or pixel level. Other types of in-loop filters may also be used in a similar manner. Operation of the deblocking filter 332 and the SAO filter 333 ideally would mimic operation of their counterparts in the coding system 200 (FIG. 2). Thus, in the absence of transmission errors or other abnormalities, the decoded frame data obtained from the in-loop filter 330 of the decoding system 300 would be the same as the decoded frame data obtained from the in-loop filter 230 of the coding system 200 (FIG. 2); in this manner, the coding system 200 and the decoding system 300 should store a common set of reference pictures in their respective prediction buffers 240, 340.

The prediction buffer 340 may store filtered pixel data for use in later prediction of other pixel blocks. The prediction buffer 340 may store decoded pixel block data of each frame as it is coded for use in intra prediction. The prediction buffer 340 also may store decoded reference frames.

As discussed, the predictor 350 may supply prediction data to the pixel block decoder 320. The predictor 350 may supply predicted pixel block data as determined by the prediction reference indicators supplied in the coded video data stream.

The controller 360 may control overall operation of the coding system 300. The controller 360 may set operational parameters for the pixel block decoder 320 and the predictor 350 based on parameters received in the coded video data stream. As is relevant to the present discussion, these operational parameters quantization parameters Q_{P} and transform modes M for the inverse transform unit 326. As discussed, the received parameters may be set at various granularities of image data, for example, on a per pixel block basis, a per frame basis, a per slice basis, a per LCU basis, or based on other types of regions defined for the input image.

Embodiments of the present provide techniques for selecting parameters for deblocking filtering.

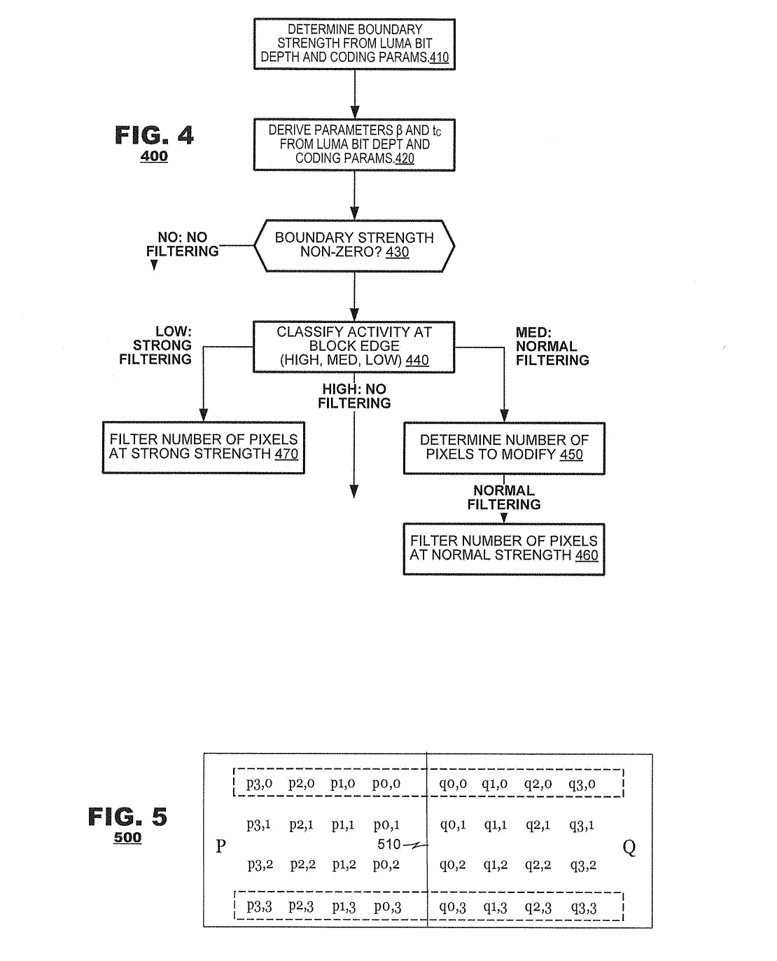

FIG. 4 illustrates a method 400 for selecting deblocking filtering parameters according to an embodiment of the present invention. The method 400 may determine a boundary strength value for pixel blocks based on a bit depth for luma components of image data and based on coding parameters of the pixel blocks (box 410). The method 400 also may derive parameters β and t_{C} based on a bit depth for luma components of image data and based on quantization parameters of the pixel block and two parameters defined in coded slice data, slice_beta_offset_div2 and slice_t_{C}_{_}offset_div2 (box 420). Both β the t_{C} parameters may be used for classifying activity of pixel blocks and the t_{C} parameter may be also used for filtering. The method 400 may determine whether the boundary strength is zero (box 430); if so, no filtering is needed.

If the boundary strength is non-zero, the method 400 may classify activity of the pixel blocks (box 440). Several classifications are possible, including high activity, medium activity and low activity. If a high activity classification is applied, no filtering is needed. If medium activity classification is applied, the method 400 may determine a number of pixels to modify (box 450). Then the method 400 may filter the determined number of pixels using either a normal filtering strength when medium activity classifications are applied (box 460) or a strong filtering strength when a low activity classification is applied (box 470).

As indicated, boundary strength values may be determined for pixel blocks based on a bit depth for luma components or chroma components of image data and based on coding parameters of the pixel blocks. As the luma/chroma bit depth gets larger, boundary strength values (BS) may get smaller, with the same conditions of prediction mode, motion vectors, reference frames, and residues. Two examples are illustrated in Table 1 and Table 2.

In the first example, as shown in Table 1, BS may be equal to 1 when one of two neighboring blocks is intra coded or when any other condition specified in the table is met. When none of the conditions are met, the boundary strength may be set to 0.

TABLE 1

| | Boundary |
|---|---|
| Conditions | Strength (BS) |
| At least one of the blocks is intra. | 1 |
| The block edge is a transform block edge and at least | 1 |
| one of the blocks has one or more non-zero transform | |
| coefficient levels. | |
| Two blocks use different reference frames or a | 1 |
| different number of motion vectors. | |
| Each block has one motion vector. And the absolute | 1 |
| difference between the horizontal or vertical | |
| component of two motion vectors is greater than or | |
| equal to 4 in units of quarter luma samples. | |
| Two motion vectors and two different reference frames | 1 |
| are used for each block. And the absolute difference | |
| between the horizontal or vertical component of two | |
| motion vectors used to predict two blocks for the | |
| same reference frames is greater than or equal to | |
| 4 in units of quarter luma samples. | |
| Each block use two motion vectors for the same | 1 |
| reference frame in the prediction. And the absolute | |
| difference between the horizontal or vertical | |
| component of list 0 (or list 1) motion vectors is | |
| greater than or equal to 4 in units of quarter luma | |
| samples. AND the absolute difference between the | |
| horizontal or vertical component of list 0 (or list | |
| 1) motion vector for one block and list 1 (or list 0) | |
| motion vector for the other block is greater than or | |
| equal to 4 in units of quarter luma samples. | |
| Otherwise | 0 |

In another example, as shown in Table 2, when bit depth is larger than 8, the boundary strength may be set to 1 if and only if one of two neighboring blocks is intra coded. The boundary strength may be set to 0 in all other cases:

TABLE 2

| | Boundary |
|---|---|
| Conditions | Strength (BS) |
| At least one of the blocks is intra. | 1 |
| Otherwise | 0 |

Parameters β and t_{C} may be derived based on a bit depth for luma components of image data and quantization parameters of the pixel block and two predefined parameters slice_beta_offset_div2 and slice_t_{C}_{_}offset_div2. In practice, a pair of tables, called a “β-table” and a “t_{C}-table” may be populated with values for use by the method 400. The β-table and the t_{C}-table may store threshold values for use in activity determinations. In an embodiment, parameters β and t_{C} may be retrieved from the β-table and t_{C}-table using indices B and T, which may be developed as:

B=Clip(0,51,qp+(slice_beta_offset_div2<<1)), where (Eq. 1.)

qp is derived from the quantization parameters of two neighboring blocks, and slice_beta_offset_div2 represents deblocking parameter offsets for β (divided by 2) provided in a coded data stream for a slice to which the current pixel blocks belong.

The index of t_{C}-table T may be determined based on both quantization parameter and BS as below.

T=Clip(0,53,qp+*2(BS−1)+(slice_t_{C}_{_}offset_div2<<1)), where (Eq. 2.)

slice_t_{C}_{_}offset_div2 is the value of slice syntax element slice_t_{C}_{_}offset_div2 and, again, may be provided in a coded data stream for a slice to which the current pixel blocks belong.

For a specific luma bit depth BD_Y, the variables β and t_{C} may be derived as in Equations (3) and (4):

β=β′*(1<<(BD_Y−8)), and (Eq. 3.)

t_{C}=t_{C}*(1<<(BD_Y−8)), (Eq. 4)

where the “<<” relation represents a shift operation by a predetermined number of bits. Thus, the variables β′ and t_{C}′ for bit depth 8, which are derived from the tables, may be left-shifted according to the real bit depth BD_Y.

If BS is larger than 0 then the method may classify activity of the pixel blocks. Pixel samples across each edge of a pair of pixel blocks may be analyzed to determine local activity. FIG. 5 illustrates an exemplary pair of pixel blocks P and Q which share a vertical boundary 510 between them. Pixel classification may be performed by analysis of pixel values at various locations within the block.

For example, pixel values may be compared against the threshold β to determine if the following relation is met:

|p2,0−2*p1,0+p0,0|+|p2,3−2*p1,3+p03,|+|q2,0−2*q1,0+q0,0|+|q2,3−2*q1,3+q0,3|<β (Eq. 5.)

If not, then high activity is present within the pixel blocks P and Q, and no filtering is required.

When BS is non-zero and the inequality in Equation (5) is met, deblocking may be applied. Deblocking may select between a normal filtering strength and a strong filtering strength based on local signal characteristics. For example, pixel values may be compared against the β and t_{C} thresholds to determine if the following relations are met:

2*|p2,2,i−2*p1,i+p0,i|+2*|q2,i−2*q1,i+q0,i|<(β>>2), (Eq. 6.)

|p3,i−p0,i|+|g0,i−q3,i|<(β>>3), (Eq. 7.)

|p0,i−q0,i|<((5*t_{C}+1)>>1), (Eq. 8.)

where the >> relation represents a right shift by a number of bit positions.

In this embodiment, if the Equations (6) (7) and (8) all hold for both i=0 and i=3, then low activity is present and a strong filter may be utilized. Otherwise, medium activity is present and a normal filter may be used.

When normal filtering strength is selected, the method 400 may decide how many pixels are modified. For example, the method 400 may determine if the inequality in Equation (9) is met, and, if so, two nearest pixels in block P could be changed in the filter operations (for example, in FIG. 5 pixels p1,i and p0,i may be changed, for all i). Otherwise, only one nearest pixel (pixels p0,i) may be changed.

|p2,0−2*p1,0+p0,0|+|p2,3−2*p1,3+p0,3|<(β+(β>>1))>>3 (Eq. 9.)

The method may select a number of pixels to be changed in block Q in a similar way, determining whether the following inequality is met:

|q2,0−2*q1,0+q0,0|+|q2,3−2*q1,3+q0,3|<(β+(β>>1))>>3 (Eq. 10.)

In strong filtering mode (box 470), the pixels may be changed as Equation (11).

p′=Clip((p−2*t_{C}),(p+2*t_{C}),p_{f}), (Eq. 11.)

where p_{f} is the impulse response of the filter corresponding to the pixel p.

In normal filtering (box 460), the modifications of pixels may occur as p′=p+d′. Before the offset d is added to the pixel, it may be clipped to d′ as:

d′=Clip(−c,c,d), (Eq. 12.)

where, for pixels p0, i and q0,i, c=t_{C} and, for pixels p1,i and q1,i, c=t_{C}>>1.

The foregoing embodiment is expected to improve operation of deblocking filters by factoring bit depth of image information in selection of deblocking parameters and, particularly boundary strength. At larger bit depths, decoded image information may be less susceptible to blocking artifacts, which lowers the need for strong deblocking. The present embodiment is expected to improve image quality, by factoring bit depth of the image information into processes that derive deblocking parameters, which may prevent deblocking filters 232 (FIG. 2), 332 (FIG. 3) from over-filtering image data where it is not needed.

In another embodiment, the index of β-table B and the index of t_{C}-table T may derived with the internal bit depth, together with BS, qp, slice_beta_offset_div2 and slice_t_{C}_{_}offset_div2, as:

B=Clip(0,51,qp+QpBdOffset_{Y}+(slice_beta_offset_div2<<1)) (Eq. 13.)

T=Clip(0,53,qp+QpBdOffset_{Y}+2*(Bs−1)+(slice_tc_offset_div2<<1)) (Eq. 14.)

where QpBdOffset_{Y} represents a value of the luma quantization parameter range offset and is calculated as:

QpBdOffset_{Y}=6*bit_depth_luma_minus8, and (Eq. 15.)

bit_depth_luma_minus8 specifies the bit depth of the luma samples minus 8.

Then the derived β′ and t_{C}′ may be directly set to β and t_{C}. There is no need to derive β and t_{C} with β′, t_{C}′, and bit depth as in Equations (3) and (4).

In a further embodiment, after β′ and t_{C}′ are derived (box 420), the parameters β and t_{C} may be modified further as:

β=β′*(1<<(BD_Y−8))*f_{β} (Eq. 16.)

t_{C}=t_{C}′*(1<<(BD_Y−8))*fₜ_{_{C}} (Eq. 17.)

In one embodiment, f_{β} and ft_{C} may be fixed coefficient values that are set smaller than or equal to 1. Alternatively, they could also be functions of luma bit depth, in which case f_{β} and ft_{C} may be decreased as bit depth gets larger.

In another embodiment, bit depth may be used to generate the thresholds for filter decisions (as in Equations 5-10 above), and the clipping range values for filter operations (as in Equation 11-12). β and t_{C} values may be derived initially without bit depth involved.

In this embodiment, a threshold X′ for filtering decisions, e.g., β in Equation (5), β>>2 in Equation (6), β>>3 in Equation (7), (5*t_{C}+1)>>1 in Equation (8) and (β+(β>>1))>>3 in Equation (9), may be calculated first independent of bit depth. Then the threshold X for a specific bit depth may derived as:

X=X′*(1<<(BD_Y−8)) (Eq. 18.)

The clipping range value P′ for filtering operations, e.g., 2*t_{C} in Equation 11, and c in Equation 12, also may be calculated first independent of bit depth. Then the clipping range value P for a specific bit depth may be derived as:

P=P′*(1<<(BD_Y−8)) (Eq. 19.)

In an embodiment, the threshold X and clipping value P for a specific bit depth could be further reduced as the bit depth gets larger, for example, as:

X=X′*(1<<(BD_{Y}−8))*h_{X} (Eq. 20.)

P=P′*(1<<(BD_{Y}−8))*h_{P} (Eq. 21.)

where hₓ and hₚ are coefficient values that smaller than or equal to 1. In one embodiment, they could be set as fixed values. Alternatively, they could vary as functions of bit depth in which hx and hp decrease as bit depth gets larger.

In a further embodiment, different filter sets may be selected for different bit depths. Consider a case where N sets of filters are used for 8 bit data, i.e., {L₀, L₁, L₂ . . . L_{N-1}} with decreasing strengths from L₀ to L_{N-1}. In such an implementation, N-d sets of filters may be candidates for use for 10 bit data (e.g., filters {L_{d}, L_{d+1}, . . . L_{N-1}}) and N-e sets of filters a may be candidates for use for image data with larger bit depth (e.g., filters {Lₑ, Lₑ₊₁, . . . L_{N-1}}). In this implementation, the filters {Lₑ, Lₑ₊₁, . . . L_{N-1}} would be candidates for use both with the 10 bit data and the larger bit depth data but filters {L_{d}, L_{d+1}, . . . Lₑ₋₁} would be candidates for use with the 10 bit data but not the larger bit depth data.

For example, at the time of this writing, the HEVC standard (ITU H.265) defines three sets of filters for use with 8 bit data. L₀ is considered a strong filter, L1 is defined as the normal filter which modifies two pixel lines nearest to a block boundary, and L₂ is defined as the normal filter which modifies one pixel line nearest to a block boundary. As proposed, no strong filter is used for 10 bit coding, so only L₁ and L₂ are used and there is no decision between strong mode and normal mode. The present embodiment would expand the set of filters that could be used for 10 bit data and would accommodate other filter definitions for image data at larger bit depths (e.g., 12-, 14- or 16-bit data).

The foregoing discussion has described the various embodiments of the present disclosure in the context of coding systems, decoding systems and functional units that may embody them. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as elements of a computer program, which are stored as program instructions in memory and executed by a general processing system. In other applications, the functional blocks may be provided as discrete circuit components of a hardware processing system, such as functional units within a digital signal processor or application-specific integrated circuit. Still other applications of the present invention may be embodied as a hybrid system of dedicated hardware and software components. Moreover, the functional blocks described herein need not be provided as separate elements. For example, although FIGS. 1-3 illustrate components of video coders and decoders as separate units, in one or more embodiments, some or all of them may be integrated and they need not be separate units. Such implementation details are immaterial to the operation of the present invention unless otherwise noted above.

Further, the figures illustrated herein have provided only so much detail as necessary to present the subject matter of the present invention. In practice, video coders and decoders typically will include functional units in addition to those described herein, including buffers to store data throughout the coding pipelines illustrated and communication transceivers to manage communication with the communication network and the counterpart coder/decoder device. Such elements have been omitted from the foregoing discussion for clarity.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method, comprising:
determining a boundary strength parameter based, at least in part, on a bit depth of decoded video data,
classifying activity of a pair of decoded pixel blocks based, at least in part, on the bit depth of the decoded video data, and
when a level of activity indicates that deblocking filtering is to be applied to the pair of pixel blocks, filtering pixel block content at a boundary at the pair of pixel blocks using filtering parameters derived at least in part based on the bit depth of the decoded video data.

2. The method of claim 1, wherein the bit depth indicates a bit depth of a luma component of the decoded video data.

3. The method of claim 1, wherein the bit depth indicates a bit depth of a chroma component of the decoded video data.

4. The method of claim 1, wherein the boundary strength parameter decreases as bit depth values increase.

5. The method of claim 1, wherein when bit depth is larger than 8 and when one of the pair of pixel blocks is intra coded, the boundary strength parameter is equal to 1.

6. The method of claim 1, wherein when bit depth is larger than 8, the boundary strength parameter is determined as in Table 1.

7. The method of claim 1, wherein when bit depth is larger than 8, the boundary strength parameter is determined as in Table 2.

8. The method of claim 1, wherein classifying activity includes deriving a threshold β from a look up table of threshold values using a table index B derived from the bit depth, quantization parameters of the pair of decoded pixel blocks and deblocking parameter offsets provided in a coded data stream for a slice to which the pair of pixel blocks belong.

9. The method of claim 1, further comprising deriving a threshold for the level of activity based on bit depth according to Equation 18.

10. The method of claim 1, further comprising deriving a threshold for the level of activity based on bit depth according to Equation 20.

11. The method of claim 1, further comprising deriving a clipping value for the level of activity based on bit depth according to Equation 19.

12. The method of claim 1, further comprising deriving a clipping value for the level of activity based on bit depth according to Equation 21.

13. The method of claim 1, wherein classifying activity includes deriving a threshold β from a look up table of threshold values using a table index B derived as:
B=Clip(0,51,qp+QpBdOffset_{Y}+(slice_beta_offset_div2<<1)), where
QpBdOffsetY represents a luma quantization parameter range offset that is derived from a bit depth of luma data of the pixel blocks, qp is derived from quantization parameters of the pair of decoded pixel blocks, and slice_beta_offset_div2 represents deblocking parameter offsets provided in a coded data stream for a slice to which the pair of pixel blocks belong.

14. The method of claim 1, wherein classifying activity includes deriving a threshold t_{C} from a look up table of clipping values using a table index T derived as:
T=Clip(0,53,qp+QpBdOffset_{Y}+2*(Bs−1)+(slice_tc_offset_div2<<1)), where
QpBdOffsetY represents a luma quantization parameter range offset that is derived from a bit depth of luma data of the pixel blocks, qp is derived from quantization parameters of the pair of decoded pixel blocks, BS represents the boundary strength parameter and slice_beta_offset_div2 represents deblocking parameter offsets provided in a coded data stream for a slice to which the pair of pixel blocks belong.

15. The method of claim 1, wherein the classifying activity comprises comparing pixel values along lines of pixels of the pair of pixel blocks that are orthogonal to the boundary determine whether the relation of Equation 5 is met.

16. The method of claim 1, wherein the classifying activity comprises comparing pixel values along lines of pixels of the pair of pixel blocks that are orthogonal to the boundary determine whether the relations of Equations 6-8 are met.

17. The method of claim 1, wherein classifying activity includes;
deriving a threshold β according to Equation 16, and
comparing pixel values to the threshold β.

18. The method of claim 1, wherein classifying activity includes:
deriving a threshold t_{C} according to Equation 17, and
comparing pixel values to the threshold t_{C}.

19. The method of claim 1, wherein the filtering comprises selecting, based on the bit depth, the filtering parameter from a plurality of predefined filtering parameters, wherein different sets of filtering parameters are candidates for selection at different bit depth values.

20. The method of claim 15, wherein, at larger bit depth values, a smaller number of sets of filtering parameters are candidates for selection than the number of sets that are candidates for selection at smaller bit depth values.

21. The method of claim 1, wherein the method operates on a device that encodes input data and decodes coded video data of reference frames.

22. The method of claim 1, wherein the method operates on a device that receives coded video data from a channel and decodes the coded video data.

23. Apparatus, comprising:
a pixel block based encoder having an input for video data and an output for coded video data,
a pixel block-based decoder having an input for the coded video data and an output for decoded video data;
a filtering system having an input coupled to the output of the pixel block based decoder, the system including a deblocking filter; and
a controller to select deblocking filtering parameters based on a bit depth of the decoded video data output from the pixel block-based decoder.

24. The apparatus of claim 23, wherein the bit depth indicates a bit depth of a luma component of the decoded video data.

25. The apparatus of claim 23, wherein the controller
determines a boundary strength parameter based, at least in part, on the bit depth of decoded video data,
classifies activity of a pair of decoded pixel blocks based, at least in part, on the bit depth of decoded video data, and
when a level of activity indicates that deblocking filtering is to be applied to the pair of pixel blocks, filters pixel block content at a boundary at the pair of pixel blocks using filtering parameters derived at least in part based on the bit depth of the decoded video data.

26. The apparatus of claim 25, wherein the boundary strength parameter decreases as bit depth values increase.

27. The apparatus of claim 25, wherein, when bit depth is larger than 8 and when one of the pair of pixel blocks is intra coded, the boundary strength parameter is equal to 1.

28. The apparatus of claim 25, wherein, when bit depth is larger than 8, the boundary strength parameter is determined as in Table 1.

29. The apparatus of claim 25, wherein, when bit depth is larger than 8, the boundary strength parameter is determined as in Table 2.

30. The apparatus of claim 25, wherein the classification includes deriving a threshold from a look up table of threshold values using a table index B derived from the bit depth, quantization parameters of the pair of decoded pixel blocks and deblocking parameter offsets provided in a coded data stream for a slice to which the pair of pixel blocks belong.

31. The apparatus of claim 25, wherein the classification includes deriving a threshold β from a look up table of threshold values using a table index B derived as
B=Clip(0,51,qp+QpBdOffset_{Y}+(slice_beta_offset_div2<<1)), where
QpBdOffsetY represents a luma quantization parameter range offset that is derived from a bit depth of luma data of the pixel blocks, qp is derived from quantization parameters of the pair of decoded pixel blocks, and slice_beta_offset_div2 represents deblocking parameter offsets provided in a coded data stream for a slice to which the pair of pixel blocks belong.

32. The apparatus of claim 25, wherein the controller selects, based on the bit depth, the filtering parameter from a plurality of predefined filtering parameters, wherein different sets of filtering parameters are candidates for selection at different bit depth values.

33. The apparatus of claim 25, wherein, at larger bit depth values, a smaller number of sets of filtering parameters are candidates for selection than the number of sets that are candidates for selection at smaller bit depth values.

34. Apparatus, comprising
a pixel block-based decoder having an input for coded video data received from a channel and an output for decoded video data;
a filtering, system having an input coupled to the output of the pixel block based decoder, the system including a deblocking filter; and
a controller to select deblocking filtering parameters based on a bit depth of the decoded video data output from the pixel block-based decoder.

35. The apparatus of claim 34, wherein the bit depth indicates a bit depth of a luma component of the decoded video data.

36. The apparatus of claim 34, wherein the controller
determines a boundary strength parameter based, at least in part, on the bit depth of decoded video data,
classifies activity of a pair of decoded pixel blocks based, at least in part, on the bit depth of decoded video data, and
when a level of activity indicates that deblocking filtering is to be applied to the pair of pixel blocks, filters pixel block content at a boundary at the pair of pixel blocks using filtering parameters derived at least in part based on the bit depth of the decoded video data.

37. The apparatus of claim 36, wherein the boundary strength parameter decreases as bit depth values increase.

38. The apparatus of claim 36, wherein, when bit depth is larger than 8 and when one of the pair of pixel blocks is intra coded, the boundary strength parameter is equal to 1.

39. The apparatus of claim 36, wherein, when bit depth is larger than 8, the boundary strength parameter is determined as in Table 1.

40. The apparatus of claim 36, wherein, when bit depth is larger than 8, the boundary strength parameter is determined as in Table 2.

41. The apparatus of claim 36, wherein the classification includes deriving a threshold from a look up table of threshold values using a table index B derived from the bit depth, quantization parameters of the pair of decoded pixel blocks and deblocking parameter offsets provided in a coded data stream for a slice to which the pair of pixel blocks belong.

42. The apparatus of claim 36, wherein the classification includes deriving a threshold β from a look up table of threshold values using a table index B derived as
B=Clip(0,51,qp+QpBdOffset_{Y}+(slice_beta_offset_div2<<1)), where
QpBdOffsetY represents a luma quantization parameter range offset that is derived from a bit depth of luma data of the pixel blocks, qp is derived from quantization parameters of the pair of decoded pixel blocks, and slice_beta_offset_div2 represents deblocking parameter offsets provided in a coded data stream for a slice to which the pair of pixel blocks belong.

43. The apparatus of claim 36, wherein the controller selects, based on the bit depth, the filtering parameter from a plurality of predefined filtering parameters, wherein different sets of filtering parameters are candidates for selection at different bit depth values.

44. The apparatus of claim 36, wherein, at larger bit depth values, a smaller number of sets of filtering parameters are candidates for selection than the number of sets that are candidates for selection at smaller bit depth, values.

45. Computer readable storage device storing instructions that, when executed by a processing device, causes the device to:
determine a boundary strength parameter based, at least in part, on a bit depth of decoded video data,
classify activity of a pair of decoded pixel blocks based, at least in part, on the determined boundary strength parameter, and
when a level of activity indicates that deblocking filtering is to be applied to the pair of pixel blocks, filter pixel block content at a boundary at the pair of pixel blocks using filtering parameters derived at least in part based on the bit depth of the decoded video data.
